(19) United States
(12) Patent Application Publication
(10) Pub. No.: US 2008/0128348 A1
(43) Pub. Date: Jun. 5, 2008

(54) Membrane Module for Separating Material

(76) Inventor: Stephan R. Blum, Calgary (CA)

Correspondence Address: K.F. ROSS P.C., 5683 RIVERDALE AVENUE, SUITE 203 BOX 900, BRONX, NY, 10471-0900, US

(21) Appl. No.: 11/885,369

(22) PCT Filed: Feb. 17, 2006
(86) PCT No.: PCT/EP06/01467

§ 371 Date: Jan. 4, 2008

(30) Foreign Application Priority Data
Feb. 18, 2005 (DE) 10 2005 007 705.6

(51) Int. Cl. B01D 63/06; B01D 63/02

(52) U.S. Cl. 210/251; 210/321.87; 210/321.89

(57) ABSTRACT

Disclosed is a membrane module for separating material, especially by means of cross-flow filtration. Said membrane module comprises a housing (1) and at least one replaceable, self-supporting filter cartridge which is disposed therein and is provided with semi-permeable hollow fiber membranes (2) that are prefer-ably placed in a longitudinal direction and are embedded in a potting compound at the ends thereof. The inventive module is characterized in that both pottings (3, 4) are equipped with final caps, particularly with sleeve-shaped front rings (7, 8) while the filter cartridge encompasses a fixture (12, 13) for attaching the final caps or font rings to the pottings.

The invention relates to a membrane module for the separation of substances, especially by crosscurrent filtration, comprising a housing and at least one self-supporting, replaceable filter cartridge mounted in it and with semipermeable filter tubes extending longitudinally that are embedded at their ends in a cast body (potting).

Such a membrane module is known from WO 2000/040325 A1 (Blum, Heggemann GmbH). This publication is expressly referenced in order to supplement the disclosure.

Furthermore, a filter cartridge consisting of a filter-tube bundle but not provided for crosscurrent filtration is known from German patent DE 35 13 789 C2 (Kronsbein).

If the pottings in accordance with the above-cited international patent application are sealed with their outer ends directly on the inside of the housing, e.g. with O-rings, it is possible when certain fluids and certain solvents contained in them are used for the seals to adhere on the outside of the pottings and on the inside of the housing. The filter cartridge can then be removed from the housing only by damaging these seals and the filter cartridge since it is very difficult to loosen this adhesion on site without damaging the O-rings and the filter cartridge.

Furthermore, it is not possible in the case of the filter cartridges in accordance with the cited international patent application that the filter-tube bundles are prefabricated with pottings on their ends, stored and replaced only later as required, which replacement should take place as simply and rapidly as possible.

The invention therefore has the basic task of solving these problems in a membrane module of the initially cited type. At the same time, the other requirements cited in the international patent application should also be met. In particular, a mounting and unmounting of the cartridge including all sealing elements into and out of the housing should be possible from only one end with only the one end of the housing having to be opened. Furthermore, the membranes should be able to be used at low temperatures, e.g.—40° C. as well as at high temperatures, e.g. approximately 400° C.

Furthermore, the membrane module and the filter cartridge should protect the membranes against sudden pressure changes.

The invention solves this task with the features of claim 1.

The holder preferably fixes the end rings positively to the pottings by means of projections and recesses.

It is furthermore suggested that the holder be designed as an intermediate tube forming the outer jacket of the cartridge and formed in turn of several shells that are longitudinally divided and connected to each other, in particular of two semicylindrical half shells that in particular have openings for letting out the permeate.

The longitudinally divided shells are preferably fastened together in a detachable manner, especially with tension bands, to the end rings and the pottings.

The advantage of the longitudinally divided intermediate tube that is detachably connected to the end rings and pottings is the possibility of being able to unmount a defective filter cartridge in a simple and rapid manner in order to replace the defective filter-tube bundle and its pottings with a new filter-tube bundle.

The pottings are preferably sealed against the end rings. In particular, the holder also fixes the end rings relative to each other.

This way, the pottings are no longer sealed directly against the housing but rather only against the ring-shaped end caps. The end caps themselves are sealed against the inside of the housing.

The end rings and the holder preferably are made of metal. If the filter cartridge must be replaced, it can be readily withdrawn along with the end rings and the holder from the housing. If the seals have adhered between the end caps and the housing, it is not a problem if the seals are damaged during replacement. The metallic sealing surfaces can be readily cleaned on site and a new seal attached. However it is important that the pottings mounted inside the end caps can be removed undamaged from the housing. Seals that may be adhered between the pottings and the end caps can be loosened later in a workshop with the suitable tools present there and without time constraint without any damage occurring to the pottings and to the filter tubes. Also, a more rapid mounting of the filter cartridge is possible due to the compact design with the front-end metallic end caps.

As has already been explained, the end rings are preferably sealed against the housing.

In a further advantageous embodiment an inlet tube and/or outlet tube is provided inside the cartridge, the length of which tube(s) can be automatically changed like a compensator and whose ends are connected to the pottings in an axially non-shiftable manner. The inlet and outlet tube preferably each comprise at least two tube sections that can slide partially into one another in a telescoping manner and/or comprise at least one longitudinally extensible and shortenable compensating coupling.

In order to achieve large production throughputs that are typical for industrial applications, instead of the individual modules it is advantageous to use a system with very many, e.g. up to approximately 20 filter cartridges, each one with individual filter-tube bundles. It is therefore suggested that the housing have several seats, one for each filter cartridge.

The filter cartridges can have a common permeate chamber located outside of the filter tubes. However, in this instance the filter-tube bundles cannot be individually turned off or turned on. Turning off would be advantageous if individual filter-tube bundles are no longer fully effective during operation or if they are damaged. A common inlet tube connected to the interiors of the filter tubes is preferably provided. Seats that are not being used can be detachably closed, that is, “set blind.” In order that the inner chamber, that is, the permeate chamber, can be heated, e.g. by product vapor, it is furthermore advantageous if the inner chamber of the housing comprises a heat exchanger, that is, internal tubing that is possibly provided with ribs.

In order to also be able to turn the filter-tube bundles off individually it is advantageous in certain instances if each seat for the filter cartridges comprises its own inlet tube provided with appropriate turn-off valves.

The essential elements of the invention are the following:
Mounting from one end,
O-rings of the pottings have no contact with the housing,
End rings held by half shells,
Several filter-tube bundles per cartridge possible,
Several cartridges per module possible.

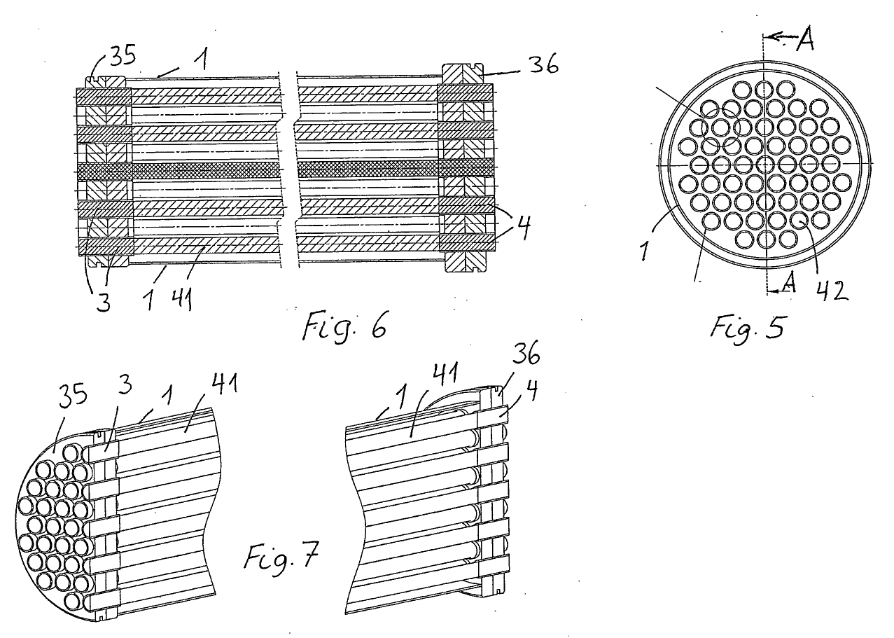

The following are also important:
The filter-tube bundles do not have to be self-supporting, the cartridge creates the stability. This is also a differentiating criterion over ceramic (rigid) membranes.
Half shells are described in the state of the art but not half shells that comprise end rings and especially not those that can permit the mounting to take place from one end.
The ability to mount the cartridges from one end.
All structural components can consist of metal but also of plastic.
The individual filter-tube bundles do not absolutely have to have a neck (see FIGS. 5-7, multi-module).
An optional internal heating.
The central tube imparts a “self-supporting property,” that is not an absolutely necessary feature of the present invention. The purpose of the compensator is to separate any sweep flow present from the product flow. Even this is not absolutely necessary,
A cartridge can contain several filter-tube bundles, e.g.
   1 filter-tube bundle per cartridge, 19 cartridges per module,
   55 filter-tube bundles per cartridge, 19 cartridges per module,
   500 filter-tube bundles per cartridge, 1 cartridge per module.

Three illustrated embodiments of the invention are discussed in detail in the following with reference made to the drawings.

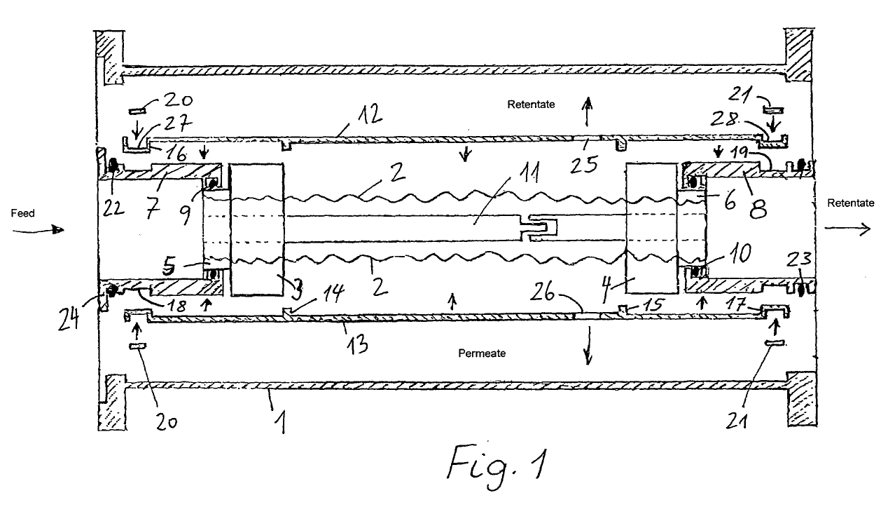

FIG. 1 is a longitudinal section in an exploded view through a membrane module in accordance with the invention and with the filter cartridge in accordance with a first illustrated embodiment,

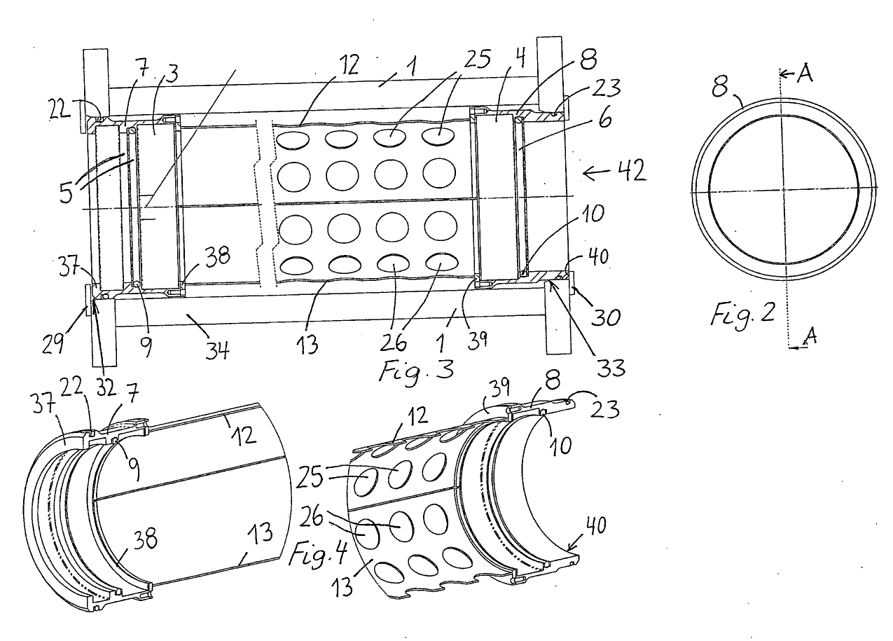

FIG. 2 is a cross section through an individual module in accordance with a second illustrated embodiment,

FIG. 3 is a longitudinal section along line A-A in FIG. 2,

FIG. 4 is a perspective view of the individual module in accordance with FIGS. 2 and 3,

FIG. 5 is a cross section through a multi-module according to a third illustrated embodiment,

FIG. 6 is a longitudinal section along line A-A in FIG. 5, and

FIG. 7 is a perspective view of the multi-module according to FIGS. 5 and 6.

In all figures the same reference numerals have the same meaning and are therefore discussed only once, if necessary.

The filter cartridge is mounted in a cylindrical housing 1 whose diameter is shown oversize in FIG. 1 in order to make it possible to show in exploded view. Filter tubes 2 are each embedded in a bundle at their ends in cast bodies 3 and 4, also called pottings. The diameters of the cylindrical pottings decreases outward away from each other so that necks 5 and 6 are formed. Sleeve-like end rings 7 and 8 are fitted over the outer surface of these necks 5 and 6 and the pottings are sealed against the end rings by seal 9 and 10 (O-rings) seated in circumferential grooves.

Both pottings 3, 4 and 5, 6 are furthermore connected to an inlet/outlet tube 11 that is also embedded in the cast body and is made of two tube sections that can be partially pushed into one another in a telescopic manner as is indicated in FIG. 1.

The pottings are fixed to each other with the end rings by two semicylindrical half shells 12 and 13 made by longitudinally cutting a tube. Radially inwardly extending projections 14, 15, 16, and 17 serve for this purpose, with the projections 16 and 17 engaged in respective circumferential grooves 18 and 19 of the end rings 7 and 8. When the half shells 12 and 13 are fitted together, two tension bands 20 and 21 engaged in respective circumferential grooves 27 and 28 and hold them firmly but detachably in position.

During assembly the filter cartridge is pushed from the left into the housing. The filter cartridge is then sealed against the outside by seals 22 and 23 fitted between the end rings 7 and 8 and the housing 1. A circumferential shoulder 24 on the outside end of front-end ring 7 serves as a stop that established the desired insertion depth of the filter cartridge into the housing 1.

During operation the feed flows from the left into the front-end ring 7, thence through the passages of the filter tubes 2 to the right end in FIG. 1, into the end ring 8, and then out of the filter cartridge as retentate. The permeate (diffusate) passing through the membranes passes at first into the chamber formed by the half shells 12 and 13 and thence outward through openings 25 and 26 in the half shells into the inner chamber of the housing 1.

The end rings 7 and 8, inlet-and outlet tube 11, half shells 12 and 13 and tension bands 20 and 21 are made of metal. The pottings 3, 4 and 5, 6 are thermoplastic plastic cast bodies. All customary membrane types can be used as the filter tubes 2.

For installation, the two closed metallic end rings 7 and 8 fitted from both ends over the necks 5 and 6 of the pottings. The two semicylindrical half shells 12 and 13 are then fitted from both sides around the filter-tube bundle with the pottings. The half shells are formed with two grooves 16 and 17 that engage in respective grooves 18 and 19 of the end rings 7 and 8. The two tension bands 20 and 21 are then fitted into the grooves 27 and 28 of the half shells 12 and 13 in order to fix the half shells firmly to the filter-tube bundle and the pottings.

The second embodiment according to FIGS. 2 to 4 is modified as follows in comparison to the first embodiment:

The filter tubes as well as the inlet-and outlet tube are not shown in FIG. 3.

The pottings are fixed to each other with the end rings by two semicylindrical half shells 12 and 13 produced by longitudinally dividing a short tube. Flanges 38 and 39 of the half shells 12 and 13 are secured by screws to corresponding flanges of end rings 7 and 8, are used for this purpose.

During assembly the filter cartridge is pushed from the left into the housing. The filter cartridge is then sealed outwardly by seals 22 and 23 fitted between the end rings 7 and 8 and the housing 1. A flange 37 of the end ring 7 and front end 40 of the end ring 8 serve with screwed-on stop rings 29 and 30 to fix the filter cartridge in housing 1.

For mounting the two closed metallic end rings 7 and 8 fitted from both ends onto the pottings. The two semicylindrical half shells 12 and 13 are fitted from both ends around the filter-tube bundle with the pottings and screwed onto flanges 38 and 39 with the inner end surfaces of end rings 7 and 8 in order to fix the half shells firmly to the filter-tube bundle and to the pottings.

All seals, which preferably consist of rubber and are designed as O-rings and seal the filter cartridge against the outside, rest between end rings 7 and 8 and housing 1 but do not touch the pottings. No seal that contacts the pottings makes contact with the housing 1, so that adhering of the pottings due to the solvent in the feed used during operation when the filter cartridge is removed does not cause any problems. As has already been explained, the filter cartridge can be mounted from one end, here on the left.

In a corresponding manner a housing can be provided with several seats for filter cartridges, e.g. for 3, 7, 19 or 55 cartridges (FIGS. 4 to 6). The filter cartridges can then be pushed as described above into the housing of the multi-module. Then, the flow is directed onto the filter-tube bundles together by one feed pipe. The filter-tube bundles share a permeate chamber. However, in this instance no filter-tube bundles can be individually turned off. If fewer filter cartridges are necessary, individual seats can be set blind, that is, plugged. The housing can optionally comprise inner tubes that are preferably provided with ribs in order to heat the inner housing chamber, e.g. with product vapor. It is also possible to provide the individual seats with separate tubes in such a manner that the filter-tube bundles can even be turned off individually.

Furthermore, in the individual module according to FIGS. 2 to 4 two input-end bevels 32 and 33 can be seen. Guide strips 34 for mounting the cartridge are also shown.

In the multi-module according to FIGS. 5 to 7 (third illustrated embodiment) 55 cartridges 42 corresponding to the cartridge in FIG. 4 with approximately 580 filter tubes each, that is, with a total of approximately 32,000 filaments can be seen.

A comparison of a cartridge with a single filter-tube bundle (FIGS. 2-4, individual module) and several filter-tube bundles (FIGS. 5-7, multi-module) will now be made. A few characterizations (A-D) will be used for the sake of simplification:

A: End ring 8 (retentate end) for individual filter-tube bundle and front plate 36 (retentate end) for several filter-tube bundles—the outside diameter of the retentate end ring and/or of the retentate front plate is 229 mm in this example.

B: End ring 7 (feed end) for individual filter-tube bundle and front plate 36 (feed end) for several filter-tube bundles: It should be considered here that the front feed ring has a somewhat smaller diameter (see FIG. 6) to simplify mounting.

C: Spacer casing (half shells 13, 14): It should be considered here that as a supplement to the above comments the spacer casing can also be tubular (FIGS. 2-4, individual module) since it can be screwed to the end rings (other type of positive closure).

D: Seal 9, 10 between potting and end ring and front plate.

### LIST OF REFERENCE NUMERALS

1 housing
2 filter tube (tubular membrane)
3 potting
4 potting
5 potting neck
6 potting neck
7 end ring
8 end ring
9 seal
10 seal
11 inlet- and outlet tube
12 half shell (holder)
13 half shell (holder)
14 circumferential projection
15 circumferential projection
16 circumferential projection
17 circumferential projection
18 circumferential groove
19 circumferential groove
20 tension band
21 tension band
22 seal
23 seal
24 shoulder
25 opening
26 opening
27 groove
28 groove
29 stop ring
30 stop ring
32 entering bevel
33 entering bevel
34 guide strip
35 front plate (feed end)
36 front plate (retentate end)
37 flange
38 flange
39 flange
40 front end
41 filter-tube bundle
42 cartridge

1. A membrane module for the separation of substances, especially by crosscurrent filtration, comprising a housing and at least one self-supporting, replaceable filter cartridge mounted in it and with semipermeable filter tubes extending longitudinally that are embedded at their ends in cast bodies wherein both cast bodies are provided with tubular end rings, and the filter cartridge comprises a holder for fixing the end caps and end rings to the cast bodies.

2. The membrane module according to claim 1 wherein the filter cartridge can be installed and removed from one end of the housing.

3. The membrane module according to claim 1 wherein the holder positively fixes the end rings to the cast bodies by projections and by recesses.

4. The membrane module according to claim 1 wherein the holder is designed as an intermediate tube forming the outer jacket of the cartridge and made of several shells that are longitudinally divided and connected to each other, and that have openings for letting out permeate.

5. The membrane module according to claim 4 wherein the longitudinally divided shells are fastened in a detachable manner to the end rings and the cast bodies.

6. The membrane module according to claim 1 wherein the cast bodies are sealed against the end rings.

7. The membrane module according to claim 1 wherein the holder fixes the end rings relative to each other.

8. The membrane module according to claim 1 wherein the end rings are made of metal.

9. The membrane module according to claim 1 wherein the holder is made of metal.

10. The membrane module according to claim 1 wherein the end rings are sealed against the housing.

11. The membrane module according to claim 1 wherein the housing comprises several seats for one filter cartridge each.

12. The membrane module according to claim 11 wherein the filter cartridges have a common permeate chamber located outside of the filter tubes.

13. The membrane module according to claim 11 wherein there is a common inlet tube connected to the interiors of the filter tubes.

14. The membrane module according to claim 11 wherein seats that are not used are closed in a detachable manner.

15. The membrane module according to claim 11 wherein the inner chamber of the housing comprises a heat exchanger.

16. The membrane module according to claim 11 wherein each seat has a separate inlet tube.
